(19) United States
(12) Patent Application Publication
(10) Pub. No.: US 2006/0182955 A1
(43) Pub. Date: Aug. 17, 2006

(54) Counterfeit and tamper evidence security labeling apparatus and method of making same

(76) Inventor: Neil G. Sellars, Cinnaminson, NJ (US)

Correspondence Address: REED SMITH LLP, 2500 ONE LIBERTY PLACE, 1650 MARKET STREET, PHILADELPHIA, PA, 19103, US

(21) Appl. No.: 11/351,937

(22) Filed: Feb. 10, 2006

Related U.S. Application Data
(60) Provisional application No. 60/654,069, filed on Feb. 17, 2005.

(51) Int. Cl. B32B 7/12; B32B 33/00; B32B 37/12; B32B 38/10; B32B 38/14

(52) U.S. Cl. 428/354; 283/81; 428/40.1; 156/277; 156/267; 156/270

(57) ABSTRACT

An apparatus for security evidence labeling a container and a method for making an apparatus for security evidence labeling a container are disclosed. The apparatus for security evidence labeling a container includes a substantially planar member, a first adhesive for affixing at least one visible indicia to the substantially planar member, at least one deadening agent for deadening the adhesive force of a portion of the first adhesive, and a second adhesive for affixing the substantially planar member, the first adhesive, and the at least one visible indicia to the container, wherein, the at least two adhesives have unequal relative strengths suitable for permitting the at least one visible indicia to separate into at least a first portion adhered to the substantially planar member and a second portion adhered to the container upon attempted removal of the substantially planar member after the substantially planar member is secured about the container.

### RELATED APPLICATIONS

This application claims priority of U.S. Patent Application Ser. No. 60/654,069, filed Feb. 17, 2005, the entire disclosure of which is incorporated by reference herein as if being set forth in its entirety.

### FIELD OF THE INVENTION

The present invention relates generally to labels and, more particularly, to labels that provide authentication, and tamper and security evidencing for containers.

### BACKGROUND OF THE INVENTION

Due to the modern complexities of product manufacturing, packaging and distribution chains, items requiring higher security have greater challenges for protection against forgery and tampering. Examples of products that are generally in need of counterfeit and security evidence containers include pharmaceutical products like Procrit® brand red blood cell enhancer. In practice, such products may be configured for sale in box containers. As current existing security labeling systems are deficient in these anti-counterfeiting and tamper evidencing measures, it is desirable to provide a means for authenticating a package, and hence included product, as genuine and undisturbed. It is also desirable to provide a means for evidencing potential tampering with the package, or contents of the package.

### SUMMARY OF THE INVENTION

An apparatus for counterfeit and security evidence labeling a container of a product, including: a substantially planar member; at least one adhesive; at least one deadening agent; and at least one visible indicia; wherein, the visible indicia is suitable for partially remaining on the container after the substantially planar member is partially altered to access a corresponding portion of the product when the apparatus is secured about the container.

A method for making an apparatus for counterfeit and security evidence labeling a container of a product, including: adhering the substantially planar member to the adhesive, then applying the deadening agent and the visible indicia; wherein, the visible indicia is suitable for partially remaining on the container after the substantially planar member is partially altered to access a corresponding portion of the product when the apparatus is secured about the container.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a profile view of a labeling apparatus according to an aspect of the present invention;

FIG. 2 illustrates a profile view of a labeling apparatus according to an aspect of the present invention;

FIG. 3 illustrates a profile view of a labeling apparatus according to an aspect of the present invention; and

FIG. 4 illustrates a flow diagrammatic view of an exemplary method for making the apparatus of FIG. 1.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in labeling and packaging apparatus, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In general, an authenticating and security evidencing label according to an aspect of the present invention may be constructed and arranged such that tearing, removing, or otherwise altering the label may render it substantially impossible to reseal the label. Such a counterfeit and security evidencing label may generally not be restored to substantially its initial appearance and condition after having been altered.

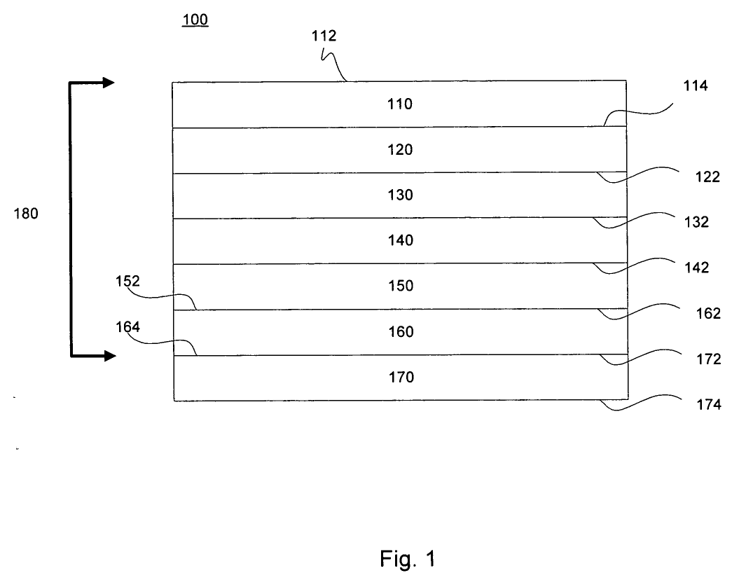

Referring now to FIG. 1, there is shown a label assembly 100 according to an aspect of the present invention. Assembly 100 may include a first member 110, a first adhesive portion 120, a silicone portion 130, a first ink portion 140, a second ink portion 150, a second adhesive portion 160 and second member 170.

Member 110 may be largely formed of any suitable substrate. For example, member 110 may take the form of a flexible substrate, such as a paper or plastic sheet or other suitable web material. By way of non-limiting example, member 110 may take the form of a biaxially oriented polypropylene sheet. Member 110 may be clear or tinted, partially or entirely transparent, opaque or translucent, depending upon design criteria. Member 110 may, or may not, include perforations corresponding to positioning of apparatus 100 with respect to a product, for facilitating partial destruction of member 110 to access a product. Such perforations may be of conventional design, such that attempted removal of apparatus 100 from a surface to which it has been attached causes an at least partial tearing of member 110.

Member 110 may have any suitable thickness, such as a thickness of approximately 2 mm. Member 110 may have generally oppositely disposed surfaces 112, 114. Surface 114 of member 110 may include or have applied thereto one or more adhesive portions 120. Member 110 may include a top coating dressing, such as, for example, TC 332, on surface 112 thereof. TC 332 may be commercially available.

Surface 112 of member 110 may be printed in a conventional manner (e.g. by flexographic, rotogravure, silk screening or other printing methods), thereby providing an amount of billboard commensurate with known techniques. Further, surface 114 of member 110 may be analogously reverse printed. Printing on surface 114 of member 110 may provide additional protection and further counterfeit and security evidence protection by protecting printed indicia under member 110.

Adhesive portion 120 may take the form of a Pressure Sensitive Adhesive (PSA) by way of non-limiting example. All or a part of adhesive portion 120 may be partially deadened.

According to an aspect of the present invention, adhesive portion 120 may take the form of a top coating adhesive, such as, for example, TC 348. TC 348 has a given adhesive strength. Adhesive 120 may include a surface 122 generally oppositely disposed from surface 114 of member 110. Surface 122 of adhesive 120 may include or have applied thereto one or more deadening portions 130. For example, surface 122 of adhesive 120 may be printed with a deadening agent in a conventional manner thereby providing a printed deadening pattern that may be continuous or non-continuous.

Deadening portion 130 may take the form of a printable deadening agent such as a silicone, or other suitable material, by way of non-limiting example. Deadening portion 130 may include a surface 132 generally oppositely disposed from surface 122 of adhesive portion 120. Surface 132 of deadening portion 130 may include or have applied thereto one or more first ink portions 140. For example, surface 132 of deadening portion 130 may be printed in a conventional manner (e.g. by flexographic, rotogravure, silk screening or other printing methods), thereby providing a printed pattern commensurate with known techniques that may be continuous or non-continuous.

Printed portion 140 may take the form of or include security indicia, such as a color shifting or variable effects ink. By way of non-limiting further example, color shifting inks are commercially available from Calyx®. Of course, other security indicia, such as patterns, may be printed in addition to or using security inks, such as the aforementioned color shifting inks.

First ink portion 140 may include a surface 142 generally oppositely disposed from surface 132 of deadening portion 130. Surface 142 of first ink portion 140 may include or have applied thereto one or more second ink portions 150. For example, surface 142 and surface 132 may be analogously printed.

Second ink portion 150 may take the form of a printable conventional or security ink. First and second ink portions 140 and 150 may be functionally cooperatively related. For example, first ink portion 140 may generally form security indicia, while second ink portion 150 forms a background for first ink portion 140. Second ink portion 150 may include a surface 152 generally oppositely disposed form surface 142 of first ink portion 140. Surface 152 of second ink portion 150 may include or have applied thereto one or more adhesive portions 160. Adhesive portion 160 may take the form of a Pressure Sensitive Adhesive (PSA), by way of non-limiting example, and may have a given adhesive force. Adhesive portion 160 may be sufficiently adhesive, for securing, for example, surface 152 to transfer tape 170.

Member 170 may be formed of any suitable substrate. For example, member 170 may take the form of a flexible substrate such as a paper or plastic sheet or other suitable web material. Member 170 may, for example, take the form of transfer tape or release liner. Member 170 may include generally oppositely disposed surfaces 172, 174. Surface 172 of member 170 may include or have applied adhesive portion 160.

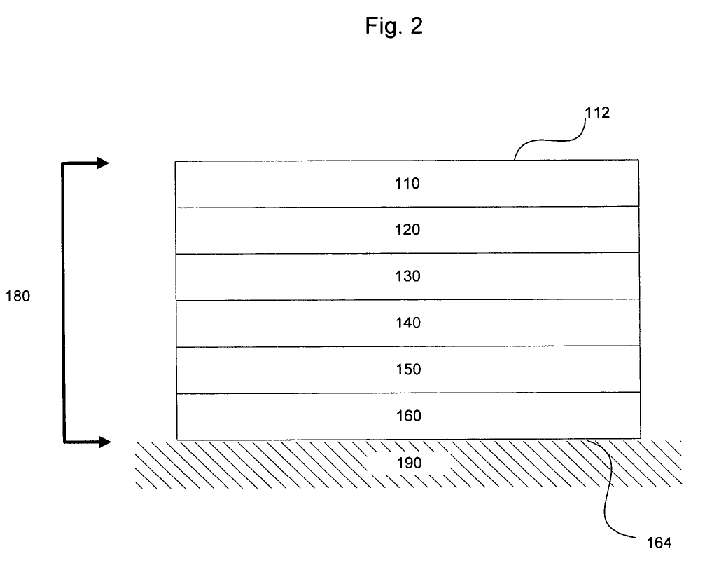

Referring now also to FIG. 2, member 170 may be removed from apparatus 100 prior to securing label portion 180 of apparatus 100 about a container 190, such that surface 164 is secured to container 190.

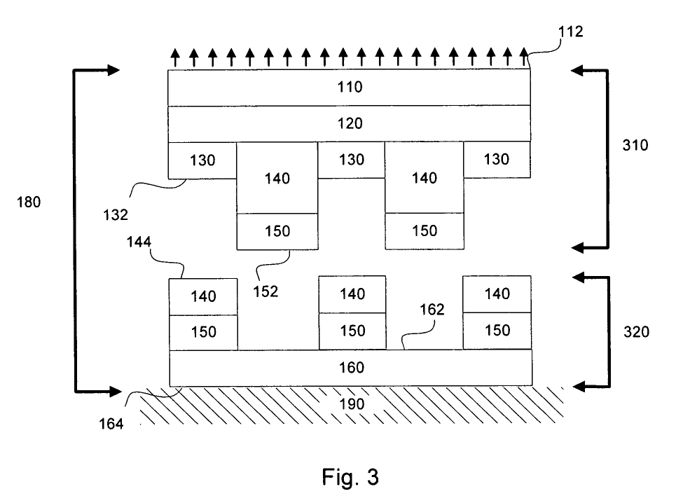

Referring now to FIG. 3, there is shown label 180 in operation. Member 180 may be formed of portion 310 and portion 320. Deadening portion 130 may secure to at least partially define portions 310 and 320. Portion 310 may include generally oppositely disposed surfaces 112 and non-continuous portions of surfaces 132 and 152. Portion 320 may include generally oppositely disposed surfaces 164 and non-continuous portions of surfaces 144 and 162. Surface 164 of member 320 may be secured to container 190. Portion 310 may be separated from portion 320 by lifting, tearing or otherwise altering the position of portion 310. Adhesive 160 may provide less adhesive force than adhesive 120, thereby permitting at least a portion of portions 130, 140 and 150, to remain adhered to member 110.

In operation, adhesive portion 120 may be adhered to deadening portion 130 and ink portion 140 such that portion ink 140 may be at least partially removed from portion 130 to enable an amount of portion 140 to remain adhered to a container following tampering with apparatus 100. The remaining amount of portion 140 may take any form, such as, by way of non-limiting example only, separated lines or words. In other words, the relative strength of adherence between portions 120/130 and 120/140 and 160/150 may be such that attempted removal or tampering with apparatus 100 causes the apparatus 100 to at least partially separate into portions 310, 320.

By way of non-limiting example only, portion 180 may be adhered to container 190 in a position suitable to partially overlay both a lid and a side so that portion 180 must be altered, removed, attempted to be removed or de-adhered from container 190 to access container 190. Container 190 may be made of a white material, such as paper board. Unaltered, portion 180 may provide a security pattern in ink which may display text, such as “Genuine.” In attempting to delaminate portion 180 to access the contents of container 190, portion 180 may be separated into portions 310, 320. The tearing away or altering of portion 180 may reveal a latent tamper evident pattern printed in silicone which may display text, such as “Do Not Use”, and a portion of container 190.

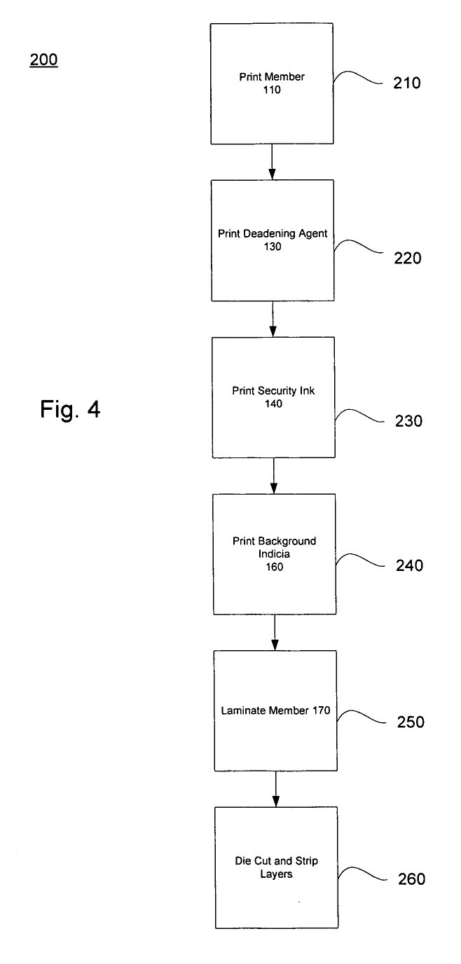

Referring now to FIG. 4, there is shown a block diagrammatic representation of a method 200 suitable for manufacturing apparatus 100.

Member 110 may be printed 210 (e.g. by flexographic, rotogravure, silk screening or other printing methods) on surface 112 and/or on surface 114. In the event that member 110 includes an adhesive on surface 114, such adhesive may optionally be deadened in select areas, such as areas other than areas corresponding to first adhesive portion 120. Otherwise, first adhesive portion 120 may optionally be provided on surface 114.

Where member 110 is provided with an adhesive, such as a pressure sensitive adhesive (PSA), on surface 114, member 110 may be delaminated from a backing layer, or release liner. Member 110 may then be printed 210, on surface 114 for example.

Surface 122 of first adhesive portion 120 may then be printed 220. Printing 220 may include printing silicone to be included on apparatus 100 and to provide partial deadening of the adhesive on surface 114. For example, discrete regions of surface 122 may be partially deadened using conventional methodologies and as has been set forth. Further, the remainder of surface 122, may be substantially completely deadened.

Surface 132 of deadening portion 130 may then be printed 230. Printing 230 may include printing first ink portion 140 on surface 132. According to an aspect of the present invention, printing on surface 132 may include printing on surface 122, as surface 122 may be only partially covered by deadening agent 130. Surface 122 may further be substantially covered by deadening agent 130.

Surface 142 of first ink portion 140 may then be printed 240. Printing 240 may, or may not, include printing second ink portion 150 to be included on apparatus 100 and to provide partial color shifting on surface 132.

Surface 152 of second ink portion 150 may then be laminated 250 to surface 162 of member 170 using conventional methodologies, the adhesive portion 160 on surface 152. According to an aspect of the present invention, adhesive portion 160 may be provided by step 250, although such is not required. For example, portion 180 may be provided for application to member 170, such that adhesive portion 160 is provided on surface 164 substantially contemporaneously with application of apparatus 100 to member 170 in a conventional manner.

Portion 180 may include a first member 110, a first adhesive portion 120, a first silicone 130, a first ink portion 140, a second ink portion 150, and second adhesive portion 160.

Die cutting and stripping 260 may include removal of portion 180 as well as trimming of members 110 and 170 to the final dimensions desired for apparatus 100. The overall dimensions of members 110 and 170 may be greater prior to die cutting and stripping 260, to facilitate die cutting and stripping of the bonded members to form apparatus 100 in a conventional manner.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. An apparatus for security evidence labeling a container, comprising:
a substantially planar member;
a first adhesive for affixing at least one visible indicia to said substantially planar member;
at least one deadening agent for deadening an adhesive force of a portion of said first adhesive, and;
a second adhesive for affixing said substantially planar member, said first adhesive, and said at least one visible indicia to said container;
wherein, the at least first and second adhesives have unequal relative strengths suitable for permitting the at least one visible indicia to separate into at least a first portion adhered to said substantially planar member and a second portion adhered to the container upon attempted removal of said substantially planar member after said substantially planar member is secured about said container.

2. The apparatus of claim 1, wherein said container is a bottle or box.

3. The apparatus of claim 1, wherein said at least one visible indicia is an ink printed to provide authentication.

4. The apparatus of claim 1, wherein said at least one visible indicia is an ink printed to provide tamper evidence.

5. The apparatus of claim 1, wherein said second adhesive is pressure sensitive adhesive.

6. The apparatus of claim 1, wherein said at least one deadening agent is printed in a tamper evidencing pattern suitable to provide tamper evidence upon said attempted removal of said substantially planar member.

7. The apparatus of claim 6, wherein said first or second portion reveals said tamper evidencing pattern.

8. The apparatus of claim 1, wherein printing said at least one visible indicia on said first adhesive and said deadening agent is suitable for authenticating the container.

9. A method for making an apparatus for security evidence labeling a container, said method comprising:
providing a substantially planar member;
applying a first adhesive to said substantially planar member;
applying to said first adhesive by printing at least one deadening agent in a tamper evidencing pattern on said first adhesive;
printing at least one visible indicia on said first adhesive and said deadening agent, wherein said at least one visible indicia is suitable for authenticating the container; and
applying a second adhesive to said at least one visible indicia, wherein the first and second adhesives have unequal relative strengths suitable for permitting the at least one visible indicia to separate into at least a first portion adhered to said substantially planar member and a second portion adhered to said container upon attempted removal of said substantially planar member after said substantially planar member is secured about said container, thereby revealing said tamper evidence pattern.

10. The method of claim 9, wherein said second adhesive is pressure sensitive adhesive.

11. The method of claim 9, further comprising the steps of: applying said second adhesive to a release liner; and die cutting said apparatus to form a label blank.

12. The method of claim 11, further comprising the steps of: stripping label substrate waste from said release paper, and rewinding said release liner bearing said label blanks into a roll or other convenient form for later application of said apparatus to said container.

13. The method of claim 9, wherein said first or second portion reveals said tamper evidencing pattern.
